(19) United States
(12) Patent Application Publication
(10) Pub. No.: US 2016/0094903 A1
(43) Pub. Date: Mar. 31, 2016

(54) MICROPHONE COMPRISING A MUTING SWITCH AND RESPIRATION MASK COMPRISING SUCH A MICROPHONE

(71) Applicant: ELNO, Argenteuil (FR)

(72) Inventors: Patrick Jean François ROBUCHON, LES ESSARTS LE ROI (FR); Julie Marie Anne ROSIER, AUVERS SUR OISE (FR); Laurent Edouard Roland HUMEN, ARGENTEUIL (FR)

(73) Assignee: ELNO, ARGENTEUIL (FR)

(21) Appl. No.: 14/891,062

(22) PCT Filed: May 14, 2014
(86) PCT No.: PCT/EP2014/059888

§ 371 Date: Nov. 13, 2015

(30) Foreign Application Priority Data
May 14, 2013 (FR) 13 54315

(51) Int. Cl. H04R 1/02; H04R 1/04

(52) U.S. Cl. CPC H04R 1/028; H04R 1/04; H04R 2499/10; H04R 2430/01

(57) ABSTRACT

The present invention relates to a microphone comprising a transducer for converting acoustic or vibratory oscillations into an electric signal; a preamplifier for amplifying the electric signal; and a controllable switch arranged electrically between the transducer and the preamplifier, the switch being adapted to be controlled by a control signal, the preamplifier including an input terminal connected directly to a terminal of the transducer, the microphone being adapted to transmit the amplified electric signal to a power and transmission device. The invention further relates to a mask comprising such a microphone.

### CROSS-REFERENCE TO RELATED APPLICATIONS

This application is the U.S. National Phase of International Patent Application Serial No. PCT/EP2014/059888, filed on May 14, 2014, which claims priority to French Patent Application No. 1354315, filed on May 14, 2013, both of which are herein incorporated by reference in their entireties.

### FIELD OF THE INVENTION

The present invention relates to a microphone comprising a transducer for converting acoustic or vibratory oscillations into an electric signal and a pre-amplifier for amplifying the electric signal.

Furthermore, the present invention relates to a respiration mask, such as oxygen mask, comprising such a microphone.

### BACKGROUND OF THE INVENTION

U.S. Pat. No. 5,159,641 A describes a respiration mask of the aforementioned type. The respiration mask comprises a valve for the respiration of a user of the mask and an inhalation detector adapted to detect opening of the valve corresponding to an inhalation by the user. The respiration mask also comprises a microphone with two wires, i.e., a microphone comprising only two terminals for transmitting an electric signal corresponding to the user's voice.

The microphone includes a transducer for converting the acoustic oscillations corresponding to the user's voice into an electric signal. The microphone further includes a muting switch controlled by the inhalation detector, the muting switch being adapted to cut the power supply of the microphone upon inhalation by the user, in order to eliminate the noise during inhalation by the user, this noise being particularly unpleasant during communication with another person.

However, if such a microphone also includes a preamplifier, it generates sharp noises during changing of the switch, in particular at the beginning and end of inhalation.

### SUMMARY OF THE INVENTION

The aim of the present invention is to propose a microphone and a respiration mask making it possible to reduce bothersome noises when switching the muting switch.

To that end, the invention relates to a microphone comprising a transducer for converting acoustic or vibratory oscillations into an electric signal, and a preamplifier for amplifying the electric signal, the microphone further comprising a controllable switch arranged electrically between the transducer and the preamplifier, the switch being adapted to be controlled by a control signal, the preamplifier including an input terminal connected directly to a terminal of the transducer and the microphone being adapted to transmit the amplified electric signal to a power and transmission device.

According to other advantageous aspects of the invention, the microphone comprises one or more of the following features, considered alone or according to any technical possible combinations:
the switch is a muting switch adapted to inhibit the transducer when it is commanded by the command signal;
the switch is movable between an open position and a closed position, and in which the switch is connected in parallel to the transducer, the switch being commanded from its open position to its closed position to inhibit the transducer;
the switch is movable between an open position and a closed position, and wherein the switch is connected in series with transducer, the switch being commanded from its closed position to its open position to inhibit the transducer;
the microphone includes only two terminals for the transmission of the amplified electric signal, and wherein the microphone is adapted to be powered via the same terminals; and
the switch is a transistor, in particular a field effect transistor, such as a MOSFET transistor.

Furthermore, the invention relates to a respiration mask, such as an oxygen mask, comprising a microphone, the microphone conforming to one embodiment according to the invention.

According to other advantageous aspects of the invention, the respiration mask comprises one or more of the following features, considered alone or according to any technical possible combinations:
the mask further comprises an inhalation or exhalation detector, and the inhalation or exhalation detector is adapted to generate the command signal of the switch; and
the mask further comprises a valve for the respiration of a user of the mask, and the inhalation or exhalation detector is adapted to detect an opening of the valve corresponding to an inhalation of the user or a closing of the valve corresponding to an exhalation of the user.

### BRIEF DESCRIPTION OF THE DRAWINGS

Other features and advantages of the present invention will emerge from the description below, done in reference to the drawings, which illustrate non-limiting example embodiments in which:

FIG. 1 is a diagrammatic view of a respiration mask comprising a microphone according to the invention;

FIG. 2 is a diagrammatic electric circuit of the microphone of FIG. 1 and its power supply;

FIG. 3 is an electric diagram of the microphone of FIG. 1; and

FIG. 4 shows curves of electric signals of a microphone of the state of the art, the microphone according to the invention and a command signal from a valve of the respiration mask and adapted to command muting of the microphone.

### DETAILED DESCRIPTION OF THE INVENTION

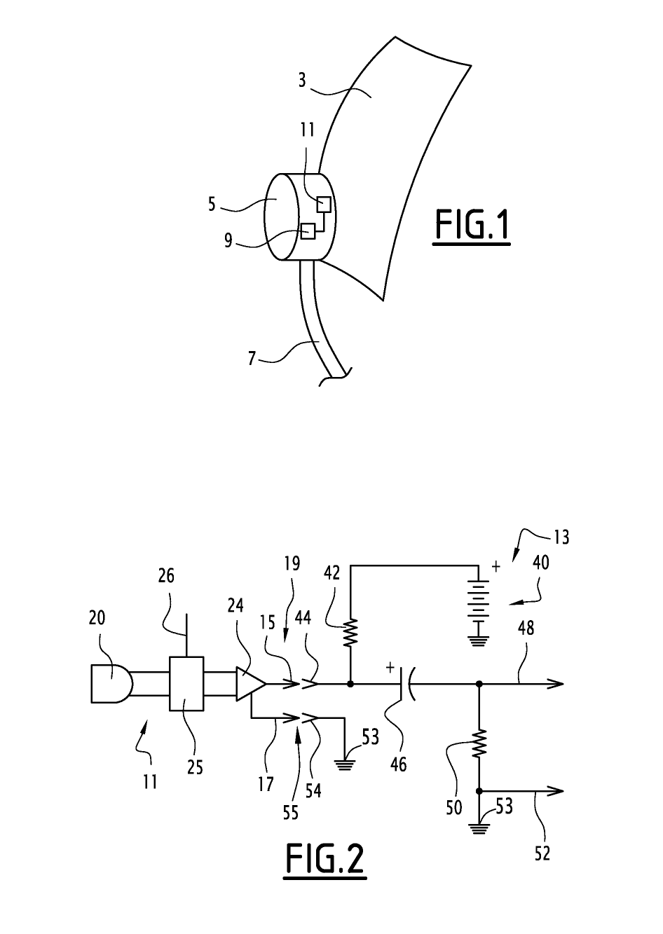

In FIG. 1, a respiration mask 1 comprises a visor 3 and a regulator 5 to which a tube 7 is connected. The respiration mask 1 allows a user to inhale gas, such as air or oxygen, coming from the tube 7, and to exhale air into that tube 7.

The respiration mask 1 comprises a valve 9 and a microphone 11, the valve 9 opening and closing during respiration by the user. The valve 9 for example opens upon an inhalation by the user and closes during an exhalation of the user.

The respiration mask 1 can be used in many applications in the civil and military fields. They are for example used by aviation pilots, such as helicopter pilots, or by firefighters or the police.

The valve 9 comprises an exhalation detector adapted to generate a command signal representing the status of the valve 9. The command signal is for example a binary signal having two states, the first state corresponding to an open state of the valve 9 and the second state corresponding to a closed state of the valve 9. The exhalation detector for example includes an electric contact positioned in the valve 9. Alternatively, the exhalation detector includes a pressure sensor.

FIG. 2 diagrammatically shows the electric circuit of the microphone 11 positioned inside the respiration mask and a power and transmission device 13. The power and transmission device 13 is arranged away from the respiration mask 1, for example in a wireless communication device or in an aircraft. Alternatively, the power and transmission device 13 is integrated into the respiration mask 1.

The microphone 11 is a microphone with two wires, i.e., a microphone comprising only two terminals 15, 17, i.e., a first terminal 15 and a second terminal 17, for transmitting an electric signal corresponding to the user's voice, these two terminals 15, 17 also being used to electrically power the microphone 11. In other words, the electric signal corresponding to an audio signal is transmitted by the same wires as the power supply of the microphone 11, and via the two terminals 15, 17.

The microphone 11 comprises a first connector 19 for connecting to the power and transmission device 13, the first connector 19 including the two terminals 15, 17.

The microphone 11 includes a transducer 20 for converting acoustic or vibratory oscillations emitted when the user speaks into an electric signal, and a preamplifier 24 to amplify said electric signal.

The microphone 11 further includes a controllable switch 25 arranged electrically between the transducer 20 and the preamplifier 24, the switch 25 being adapted to be controlled by a command signal. The microphone 11 includes a command terminal 26 for receiving the command signal, the command signal for example coming from the inhalation detector of the valve 9.

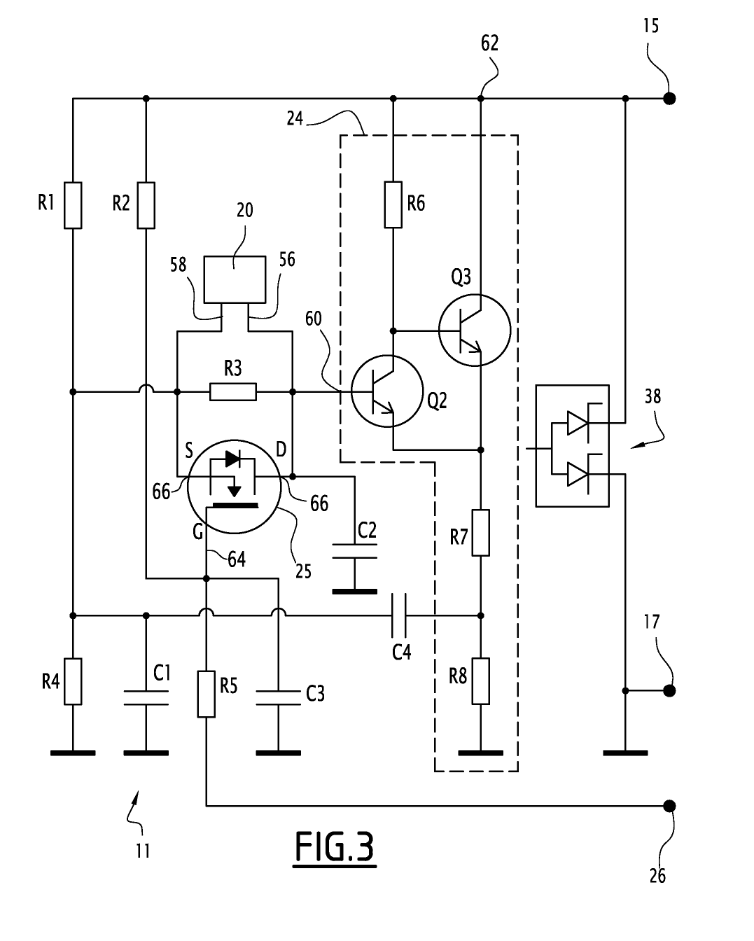

The microphone 11 additionally includes a filter 38, shown in FIG. 3, connected between the two terminals 15, 17. The filter 38 is for example an electromagnetic compatibility (EMC) filter adapted to protect the transducer 20 and the preamplifier 24 from electromagnetic disturbances, in particular against overvoltages.

The power and transmission device 13 comprises an energy source 40, for example a DC power source, adapted to provide a voltage, for example a DC voltage, with a value preferably comprised between 8 V and 16 V. The DC power source 40 includes a battery in the embodiment of FIG. 2.

The power and transmission device 13 comprises a first resistance 42 and a first terminal 44 complementary to the first terminal 15 of the microphone 11, the first resistance 42 being connected between the DC power source 40 and the first additional terminal 44.

The power and transmission device 13 comprises a capacitor 46, forming a high pass filter, and a first audio output 48, the capacitor 46 being connected between a first complementary terminal 44 and the first audio output 48.

The power and transmission device 13 comprises a second resistance 50 and a second output 52, the second resistance 50 being connected between the first audio output 48 and the second output 52. The second resistance 50 is also connected to an electric ground 53. The first and second outputs 48, 52 are for example connected to a wireless transmission system, or to an audio frequency voltmeter, a level recorder, and/or a distortion analyzer during a development phase of the microphone.

The power and transmission device 13 comprises a second terminal 54 complementary to the second terminal 17 of the microphone 11, and a second connector 55 for connecting to the microphone 11, the second connector 55 including the two complementary terminals 44, 54, as shown in FIG. 2. The second connector 55 is adapted to be connected to the first connector 19 to establish the electric connection, for example via two wires, between the microphone 11 and the power and transmission device 13.

The first terminal 15 is adapted to transmit the amplified electric signal, corresponding to a baseband amplified audio signal, coming from the microphone 11, and also to send a current, for example a DC current, to power the transducer 20 and the preamplifier 24 of the microphone.

The first connector 19 is for example arranged in the regulator 5 or in the communication device.

The transducer 20 is a transducer with two wires adapted to transmit the electric signal corresponding to the baseband information on the same wires as its power supply. The transducer 20 then includes two terminals 56, 58, i.e., a first terminal 56 and a second terminal 58.

The transducer 20 is for example an electroacoustic transistor adapted to convert acoustic oscillations, corresponding to the user's voice transmitted aerially, into an electric signal. For example, the transducer 20 is an electrostatic transducer, such as a dynamic transducer or an electret transducer.

Alternatively, the transducer 20 is a mechanical bone excitation transducer, also called osteophonic transducer, adapted to convert the vibratory oscillations of a sound signal coming from the user's vocal cords into an electric signal. According to this alternative, the transducer 20 of the microphone is an accelerometer adapted to receive, by bone conduction, in particular through the mandibular bone of the skull, the vibratory waves from the sound signal coming from the vocal cords and converted into the electric signal.

The preamplifier 24 includes an input terminal 60 and at least one output terminal 62, the input terminal 60 preferably being connected directly to one of the terminals 56, 58 of the transducer 20, and the output terminal 62 being sent to the first terminal 15 of the microphone for transmission of the amplified signal by said preamplifier.

The preamplifier 24 is adapted to amplify the audio signal that is applied to its input terminal 60, given that the electric signal generated by the transducer 20 has generally a too low amplitude to be transported to the destination, for example to a wireless communication device or a power amplifier. The voltage at the input terminal 60 is preferably comprised between 0.5 mV and 5 mV RMS, and the voltage of the output terminal 62 [is] preferably comprised between 10 mV and 30 mV RMS.

The preamplifier 24 comprises two bipolar transistors Q2 and Q3 and resistances R6, R7 and R8. The preamplifier 24 is adapted to amplify an electric signal, for example the baseband audio signal, applied to its input terminal 60 and to deliver the amplified signal to the first terminal 15. In the example embodiment of FIG. 3, the pre-amplifier 24 is a two-stage amplifier. Alternatively, other preamplifiers are used, for example with one stage or with more than two stages.

The controllable switch 25 is a muting switch adapted to inhibit the transducer 20 when it is commanded by the command signal received via the command terminal 26.

The controllable switch 25 includes a command electrode 64 adapted to receive the command signal, for example from the valve 9, and two conduction electrodes 66. The switch 25 is controllable between an open position, in which no current circulates between the conduction electrodes 66, and a closed position, in which the current is adapted to circulate between the conduction electrodes 66.

In the example embodiment of FIG. 3, the controllable switch 25 is connected in parallel with the transducer 20, the switch 25 then being commanded from its open position to its closed position to inhibit the transducer 20. In other words, when the switch 25 is in the closed position, it forms a shunt of the transducer 20. The conduction electrodes 66 are each connected to a respective terminal 56, 58 of the transducer 20 in this example. According to this example, the microphone 11 comprises a resistance R3 connected in parallel with the transducer 20 and the switch 25. The resistance R3 makes it possible to polarize the transistor 25 by supplying it with corresponding base current. In other words, the transistor 25 is fed via the resistance R3.

In an alternative that is not shown, the controllable switch 25 is connected in series with the transducer 20, the switch 25 then being commanded from its closed position to its open position to inhibit the transducer 20. In other words, when the switch 25 is in the open position, it then cuts the power supply of the transducer 20. According to this alternative, only one of the two conduction electrodes 66 of the switch is connected to a respective terminal 56, 58 of the transducer.

The switch 25 is for example a transistor, in particular a field effect transistor. In the example embodiment of FIG. 3, the switch 25 is a metal oxide semiconductor field effect transistor (also called a MOSFET transistor). The control electrode 64 is then a gate electrode G, and the conduction electrodes 66 are the source S and drain D electrodes.

The control terminal 26 is connected to the control electrode 64, for example by means of a resistance R5, for the transmission of the command signal from the valve 9 to the switch 25. The resistance R5 is a current-limiting resistance adapted to protect the gate electrode G of the transistor 25. The command signal is adapted to command closing of the switch 25 when the switch 25 is connected in parallel with the transducer 20, as shown in FIG. 3. Alternatively, the command signal is adapted to command the opening of the switch 25 when the switch 25 is connected in series with the transducer 20.

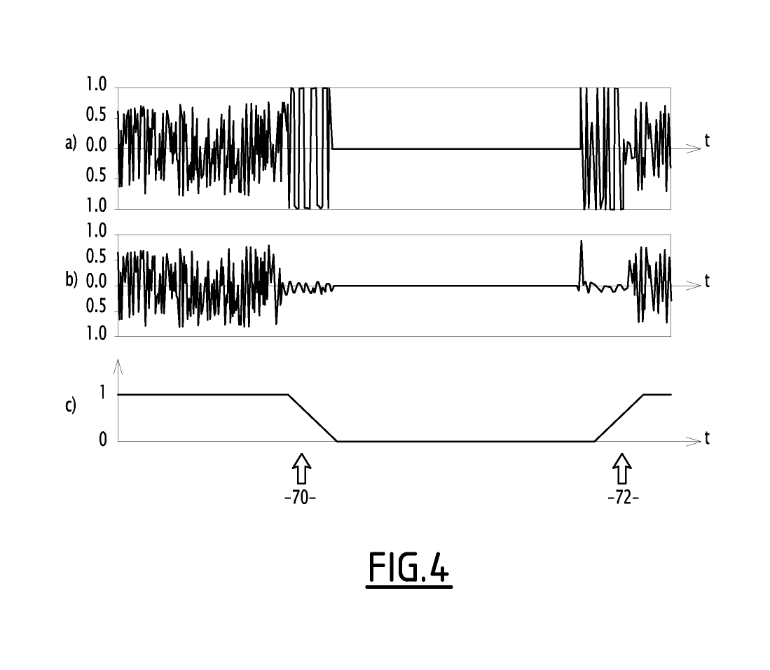

Below, the operation of the microphone 11 according to the invention will be explained using FIG. 4, which shows a first curve a) of an audio signal of a microphone of the state of the art in which the muting switch of the microphone is arranged in series between the microphone and the power supply, i.e., between the preamplifier and the power and transmission device.

The second curve b) shows the baseband audio signal obtained with the microphone 11 according to the invention.

The third curve c) shows the command signal used to command the switch 25 for muting the microphone.

The curves of FIG. 4 illustrate the use of the microphone in the respiration mask 1. The first curve a) and the second curve b) are normalized. The three curves a), b) and c) are aligned over time t.

With the microphone of the state of the art (curve a), the inhalation noise is cut by a switch that is arranged between the microphone and the power and transmission device. The switch is controlled by the command signal (curve c) having two states, i.e., a first state in which the person using the mask is speaking and a second state corresponding to an exhalation by the user.

The period corresponding to the beginning of the exhalation is designated by reference 70, and that corresponding to the end of exhalation is designated by reference 72. At the beginning of exhalation, the audio signal is cut (period 70), and at the end of exhalation, the muting is interrupted and the audio signal is once again transmitted (period 72).

Curve a) clearly shows that with the microphone of the state of the art, the change in status of the muting switch generates significant noise, in particular an audible sound, upon extinction of signal (period 70). A similar noise is also generated at the end of muting (period 72).

With the microphone 11 according to the invention, when the command signal is in its first state, the transducer 20 converts the oscillations received into an electric signal and transmits it via its terminal 56 to the input terminal 60 of the preamplifier 24. This electric signal corresponds to the baseband audio signal. The audio signal is identified by the preamplifier 24 and is transmitted by the first terminal 15 to the power and transmission device 13. The audio signal passes through the high pass filter or capacitor 46 to the first audio output 48 of the device 13.

When the person using the mask 1 exhales, the command signal changes from its first state to its second state. In this case, the switch 25 inhibits the transducer 20. A DC current is then applied on the input terminal 60 of the preamplifier 24.

As shown by curve b) of FIG. 4, the generated noise caused by the muting of the microphone 11 (period 70), as well as the elimination of the muting to once again transmit the audio signal corresponding to the user's voice (period 72), is greatly reduced.

The arrangement of the switch 25 between the transducer 20 and the preamplifier 24 thus makes it possible to greatly reduce the audio noises corresponding to the switching of the switch 25.

In another embodiment, the microphone is muted upon inhalation by the user. For example, in the event the oxygen or air is pressurized, the inhalation creates noise. In this case, the respiration mask includes an inhalation detector instead of an exhalation detector.

One can thus see that the microphone 11 according to the invention makes it possible to reduce bothersome noises during switching of the muting switch 25 and to provide a higher-quality baseband audio signal.

1. A microphone, comprising:
a transducer for converting acoustic or vibratory oscillations into an electric signal;
a preamplifier for amplifying the electric signal, and
a controllable switch arranged electrically between the transducer and the preamplifier, the switch being adapted to be controlled by a control signal, characterized in that the preamplifier including an input terminal connected directly to a terminal of the transducer, the microphone being adapted to transmit the amplified electric signal to a power and transmission device.

2. The microphone according to claim 1, wherein the switch is a muting switch adapted to inhibit the transducer when the switch is commanded by the command signal.

3. The microphone according to claim 1, wherein the switch is movable between an open position and a closed position, and wherein the switch is connected in parallel to the transducer, the switch being commanded from its open position to its closed position to inhibit the transducer.

4. The microphone according to claim 1, wherein the microphone includes only two terminals for the transmission of the amplified electric signal, and wherein the microphone is adapted to be powered via the same terminals.

5. The microphone according to claim 1, wherein the switch is a transistor, in particular a field effect transistor, such as a MOSFET transistor.

6. A respiration mask, such as an oxygen mask, comprising a microphone,
wherein the microphone comprises:
a transducer for converting acoustic or vibratory oscillations into an electric signal; and
a preamplifier for amplifying the electric signal, and
wherein the microphone further including a controllable switch arranged electrically between the transducer and the preamplifier, the switch being adapted to be controlled by a control signal, wherein the preamplifier including an input terminal connected directly to a terminal of the transducer, the microphone being adapted to transmit the amplified electric signal to a power and transmission device.

7. The mask according to claim 6, wherein the mask further comprises an inhalation or exhalation detector, and the inhalation or exhalation detector is adapted to generate the command signal of the switch.

8. The mask according to claim 7, wherein the mask further comprises a valve for the respiration of a user of the mask, and the inhalation or exhalation detector is adapted to detect an opening of the valve corresponding to an inhalation of the user or a closing of the valve corresponding to an exhalation of the user.
